(19) United States
(12) Patent Application Publication
(10) Pub. No.: US 2015/0312738 A1
(43) Pub. Date: Oct. 29, 2015

(54) SYSTEMS AND METHODS FOR OBTAINING IN BUILDING LOCATION DATA FOR VOIP PHONES FROM NETWORK ELEMENTS

(71) Applicant: Connexon Telecom, Inc., Montreal (CA)

(72) Inventors: Lev Deich, Hampstead (CA); Allan Gaspe, Kanesatake (CA)

(73) Assignee: Connexon Telecom, Inc., Montreal (CA)

(21) Appl. No.: 14/260,498

(22) Filed: Apr. 24, 2014

(51) Int. Cl. H04W 4/22; H04M 3/51; H04W 4/04; H04M 3/42; H04W 4/02; H04W 64/00

(52) U.S. Cl. CPC H04W 4/22; H04W 4/025; H04W 64/003; H04W 4/043; H04M 3/42357; H04M 3/5116

(57) ABSTRACT

An emergency call handling system can route an emergency call received from a caller to an appropriate public safety answering point (PSAP) and provide the PSAP with an emergency response location (ERL) of the caller. The ERL of the caller can include, in addition to a civic address, floor, wing, sector, room, etc., information associated with the caller. The system can include a location information server (LIS) for obtaining and storing the ERLs associated with the callers. A network element, to which the caller's phone is connected, can be configured to store the location information of the caller's phone. The LIS can be configured to store a validated civic address of the network element and obtain the location information of the phone dynamically from the network element. The LIS can then combine the civic address of the network element with the location information of the network element to determine a complete ERL of the caller.

### FIELD

The present application generally relates to data communication networks. In particular, the present application relates to systems and methods obtaining location data from network elements for emergency phone call handling.

### BACKGROUND

An emergency call handling system can route an emergency call received from a caller to an appropriate public safety answering point (PSAP) and provide the PSAP with an emergency response location (ERL) of the caller. The ERL of the caller can include, in addition to a civic address, floor, wing, sector, room, etc., information associated with the caller.

### BRIEF SUMMARY

Typical Voice over IP (VOIP) emergency call systems route emergency (e.g., 911) calls to an appropriate Public Safety Answering Point. Each emergency call is associated to an Emergency Reponses Location (ERL) which indicates the location of the caller initiating the emergency call. The ERL can be displayed at the Public Safety Answering Point (PSAP) upon answering the emergency call.

In situations where the emergency caller is located in a large building or campus, the street address alone may not be sufficient when trying to effectively and quickly locate the caller. Local regulations, as well as concerns about public safety and liability, may behoove enterprises to provide more granular location data, such as wing, floor, sector, or room. To this end, enterprises must deal with the challenge of maintaining the correct ERL for each phone in an environment where phone moves occur very often between these granular locations.

In some implementations, the ERL for a VoIP phone can be determined by communicating with a network element at the enterprise that provides network access to the VoIP phones. A network element can include a communication device such as a network switch, a local area network switch, a wireless local area network (WLAN) access point, etc. The network element can include several network interfaces via which the VoIP phones, or other network devices, can communicate with the network element. In implementations, where the network element is a WLAN access point, the network interfaces can include wireless communication channels. The wireless communication channels can be utilized by the VoIP phones to communicate with the WLAN access point. In other implementations, where the network element is a network switch (e.g., an Ethernet switch), the network interfaces can include physical ports, which can be connected, via cables, to the VoIP phones or other network devices. The systems and methods discussed herein are applicable to any network element providing network access to the VoIP phones via any kind of network interface.

VOIP discovery methods associate a VOIP phone's ERL by a Simple Network Management Protocol (SNMP) polling mechanism that connects to network elements, such as network switches, local area network access points, wireless network access points, wireless network access switches, etc., to discover the VoIP phone Media Access Control (MAC) and the network interface to which the VOIP phone is connected. In some implementations, where the network element is, for example, a WLAN access point (which, unlike a wired network switch, may not include physical network ports), the polling mechanism can discover the VoIP MAC address and the wireless channel (for example, a communication channel defined as per IEEE 802.11) over with the VoIP communicates with the WLAN access point. In some implementations, where the network element is a wired network switch, for example, an Ethernet switch, the polling mechanism can discover the VoIP MAC address and the name of the physical port to which the VoIP phone is connected. The results of the polling mechanism are then compared to a network map, which documents the physical location of each network port. The ERLs are then stored in a Location Information Server (LIS). In some implementations, VOIP discovery methods may utilize management protocols other than SNMP for determining the ERL of the VOIP phone.

The overhead of creating and maintaining an up to date network map for each network element port in a LIS is a significant challenge. This is compounded further by the fact that the information technology (IT) resources normally used to manage network elements (such as, for example, Ethernet switches, wireless access points, etc.) are usually different than one ones managing the LIS.

In some aspects of the present solution, the ERL management can be simplified by allowing the IT resources to include port location information within port configuration information associated with the ports. The LIS can then be allowed to obtain the port location data as part of the polling mechanism. The LIS can then determine the ERL of the terminals by obtaining the port locations and discovering the VOIP phones connected to the ports.

In some other aspects of the present solution, an ERL associated with a VOIP phone can include a civic address of the network element to which the VOIP phone is connected in addition to the location information (LOC) of the VOIP phone within the caller site. The LOC can include the port location information of the port to which the VOIP phone is connected.

In some other aspects of the present solution, the LIS can store the civic address associated with the network element without storing the LOC of the VOIP phones. Instead, the civic address can be validated by an address validation authority to ensure that the civic address is valid for emergency 911 applications, and the LOC for a caller can be obtained dynamically (using polling mechanisms) when the caller initiates an emergency call. This is in contrast with some traditional applications in which the LIS stores both the civic address and the LOC.

In some other aspects, the LIS can store the civic address without the LOC, as mentioned above, in response to a new network element being connected to the network, or in response to a change in a civic address of a network element. The LIS can then validate the civic address of the network element. Subsequently, the LIS can associate the network element with the civic address and store the civic address in an LIS database.

In some aspects of the present solution, the network administrator can be allowed to configure the port configurations of each port of the network element to which a VOIP phone is connected to include the location information of the port. This is in contrast with some traditional applications in which the network administrator stores the civic address of the network element in addition to the port location information. This is also in contrast with some other traditional applications in which the network element stores an emergency location ID number associated with the VOIP phone.

In some aspects of the present solution, the LIS can discover the network addresses and/or physical addresses (such as, for example, the MAC addresses) of the VOIP phones and the port location information of each port at the network element by using polling mechanisms. The LIS can determine the ports to which the VOIP phones are connected and create ERL associated with each VOIP phone. The ERLs can include the civic address of the network element in their civic address field. Further, location information (LOC) of each ERL for a VOIP phone can include the port location information of the port to which the VOIP phone is connected. This aspect of the present solution is in contrast with some traditional applications, in which the LIS discovers the complete ERL (including the civic address and the LOC) from the port configuration.

In some aspects, the present solution is directed to a method for determining a location of a phone of a network switch by a location information server for an emergency response location. The method includes (a) storing, by a location information server (LIS), in a database a civic address assigned to a network switch for an emergency response location (ERL), location information of the phone connected to the network switch at the civic address to be included with the civic address for the ERL record for the phone and to be obtained from the network switch. The method further includes (b) sending, by the LIS, a query to the network switch to obtain information on a port of the network switch connected to the phone; (c) receiving, by the LIS from the network switch in response to the query, location information for the port configured on the network switch; and (d) creating, by the LIS, the ERL record for the phone to include the location information of the port of the phone received by the network switch with the civic address stored by the LIS.

In some aspects, the present solution is directed to a system for determining a location of a phone of a network switch by a location information server for an emergency response location. The system includes, a location information server (LIS) configured to store in a database a civic address assigned to a network switch for an emergency response location (ERL), location information of the phone connected to the network switch at the civic address to be included with the civic address for the ERL record for the phone and to be obtained from the network switch. Further, the LIS is configured to send a query to the network switch to obtain information on a port of the network switch connected to the phone, and in response to the query, receive from the network location information for the port configured on the network switch; and create the ERL record for the phone to include the location information of the port with the civic address.

In some aspects, the present solution is directed to a method for determining a location of a phone of a network switch by a location information server for an emergency response location. The method includes (a) storing, by a location information server (LIS), in a database a partial emergency response location (ERL) record comprising a civic address assigned to a network switch, the partial ERL record to be completed with at least a location information of a phone at the civic address stored on the network switch. The method further includes (b) sending, by the LIS in response to the request, a query to the network switch to obtain location information on a port of the network switch connected to the phone; (c) receiving, by the LIS from the network switch in response to the query, the location information for the port configured on the network switch; (d) completing, by the LIS, the ERL record for the phone by storing the location information of the port received from the network switch with the civic address stored by the LIS; (e) receiving, by the LIS, a request for the ERL of the phone of an emergency caller at the civic address, the phone connected to the network switch; and (f) providing, by the LIS, the complete ERL record for handling an emergency call of the emergency caller from the phone by a public safety answering point.

The details of various embodiments of the invention are set forth in the accompanying drawings and the description below.

### BRIEF DESCRIPTION OF THE FIGURES

The foregoing and other objects, aspects, features, and advantages of the invention will become more apparent and better understood by referring to the following description taken in conjunction with the accompanying drawings, in which:

FIG. 1A is a block diagram of an embodiment of a network environment for a client to access a server via a network;

FIG. 1B is a block diagram of an embodiment of an environment for delivering a computing environment from a server to a client via a network;

FIG. 1C is a block diagram of an embodiment of a computing device useful for practicing an embodiment of one or more appliances shown in FIGS. 1A and 1B;

FIG. 1D is a block diagram of another embodiment of a computing device useful for practicing an embodiment of one or more appliances shown in FIGS. 1A and 1B;

FIG. 2 shows an example system 200 for supporting voice over IP (VOIP) emergency calls;

FIG. 3 shows example port configuration information including location information associated with a network element port;

FIG. 4 shows a list of emergency response locations (ERLs) associated with a corresponding list of phone-IDs;

FIG. 5 shows an example flow diagram of a process for processing, at a location information server, emergency response locations (ERLs) associated with terminals at a call site; and

FIG. 6 shows an example flow diagram of another process for processing, at a location information server, emergency response locations (ERLs) associated with terminals at a call site.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION OF THE INVENTION

For purposes of reading the description of the various embodiments below, the following descriptions of the sections of the specification and their respective contents may be helpful:
Section A describes a network environment and computing environment which may be useful for practicing embodiments described herein;
Section B describes embodiments of systems for processing emergency calls; and
Section C describes embodiments of operations of a location information server.

### A. Network and Computing Environment

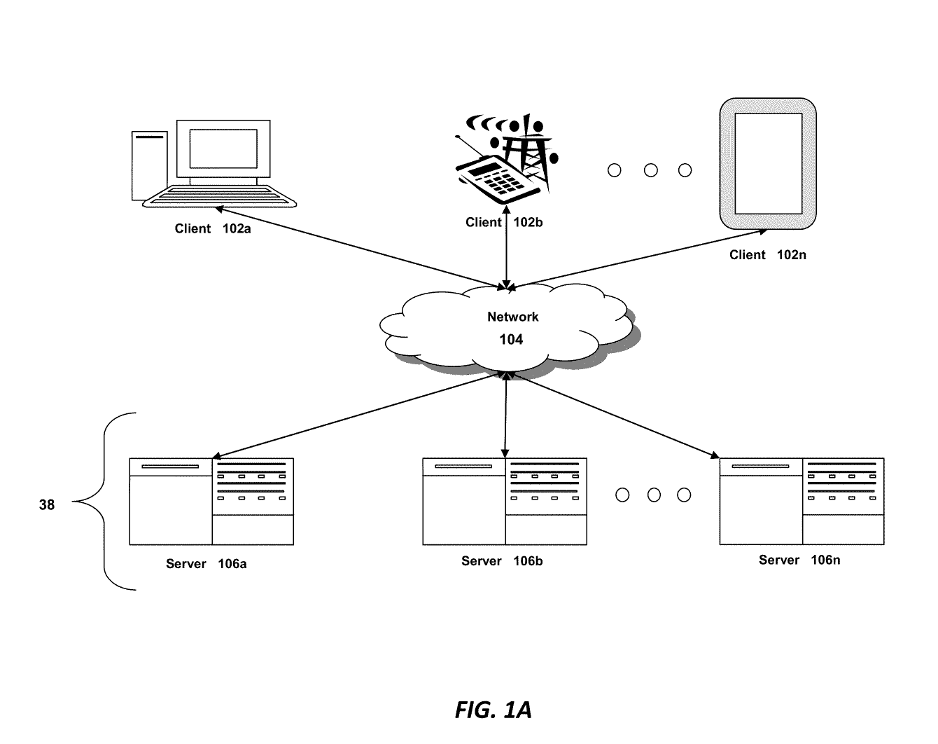

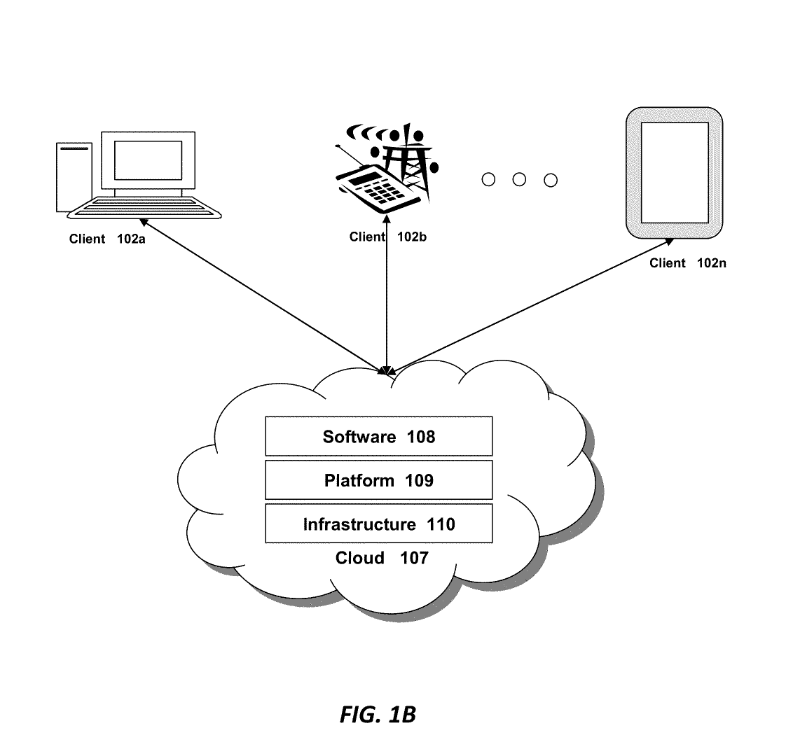

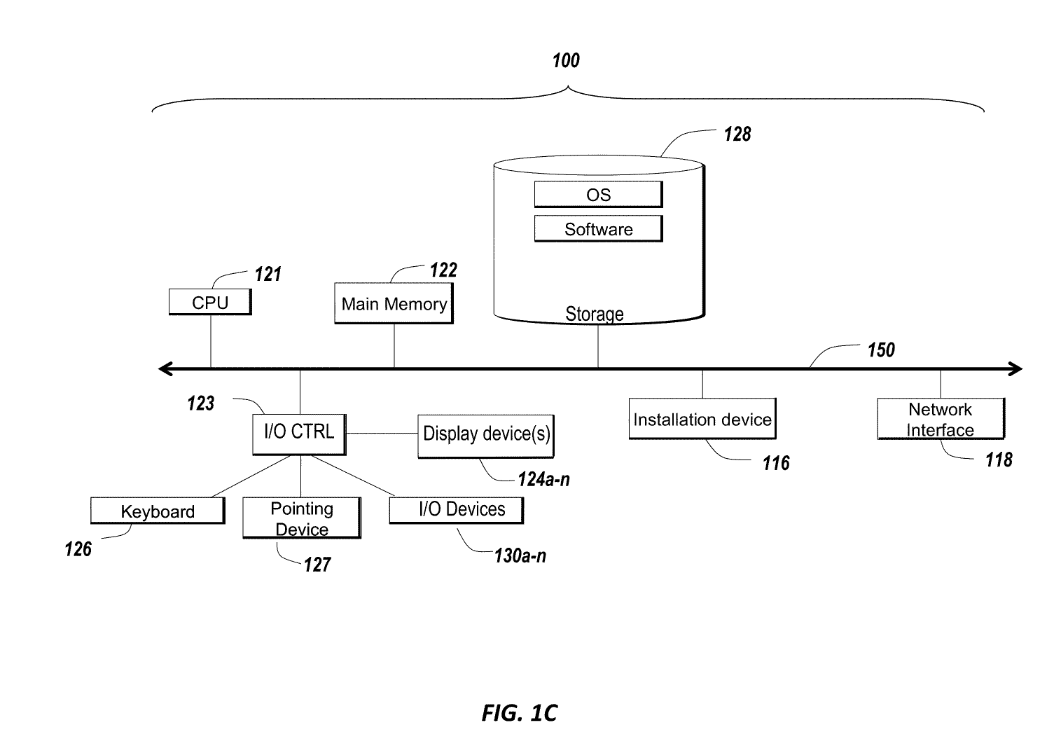

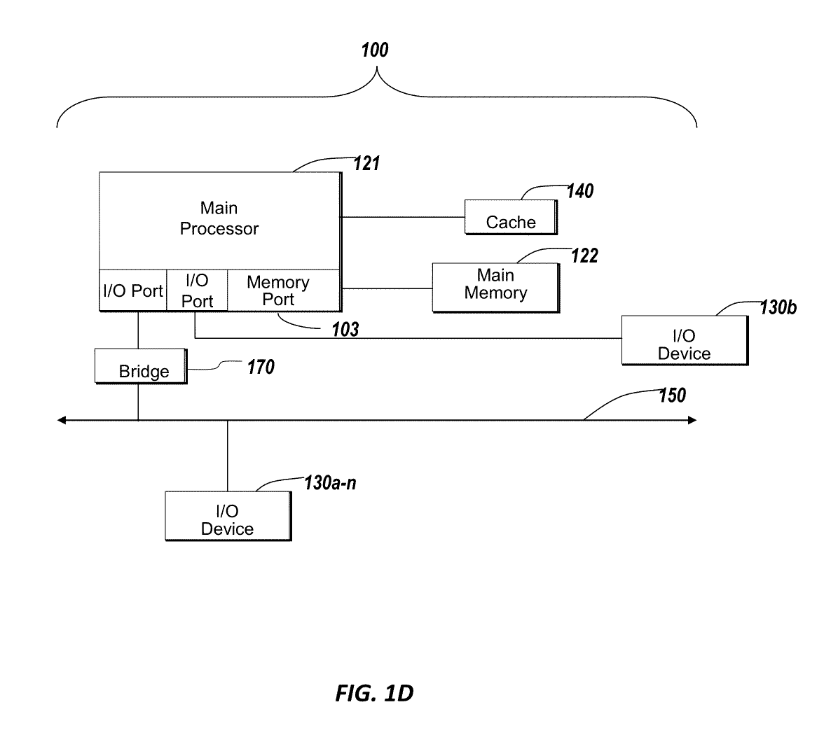

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104 may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include Bluetooth, Wi-Fi, Worldwide Interoperability for Microwave Access (WiMAX), an infrared channel or satellite band. The wireless links may also comprise of any cellular network standards used to communicate among mobile devices, including standards that qualify as 1G, 2G, 3G, or 4G. The network standards may qualify as one or more generation of mobile telecommunication standards by fulfilling the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards use different channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers of stacks of protocols, including e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the Hyper-V hypervisors provided by Microsoft or others. Hosted hypervisors may run within an operating system on a second software level. Examples of hosted hypervisors may include VMware Workstation and VirtualBox.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud computing environment may provide the client 102 with the same resources as a network environment. The cloud computing environment includes one or more front end clients 102a-102n, in communication with the cloud 107 over one or more networks 104. Front end clients 102 include thick clients, thin clients, and zero clients. A thick client 102 may offer much functionality even when disconnected from the cloud 107 or servers 106, and a thin client or a zero client may depend on the connection to the cloud 107 or server 106 to provide functionality. A zero client may depend on the cloud 107 or other networks 104 or servers 106 to retrieve operating system data for the client device. The network 104 may be internet, intranet, any networks described herein, or any other type of network. The cloud includes back end platforms, e.g., servers 106 and storage, server farms 38 or data centers.

The cloud 107 may be public, private, or hybrid. Public clouds may include public servers 106 that are maintained by third parties to the clients 102 or the owners of the clients, where the servers 106 or server farms 38 and data centers may be located off-site in remote geographical locations as disclosed above or otherwise. Public clouds may be connected to the servers 106 over a public network e.g. the internet. Private clouds may include private servers 106 that are physically maintained by clients 102 or owners of clients, where the servers 106 may be physically located on the premise. Private clouds may be connected to the servers 106 over a private network 104 e.g. an intranet network. Hybrid clouds 107 may include both the private and public networks 104 and servers 106.

The cloud 107 may also include a cloud based delivery, e.g. Software as a Service (SaaS) 108, Platform as a Service (PaaS) 109, and Infrastructure as a Service (IaaS) 110. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include Amazon Web Services, Rackspace Cloud, Google Compute Engine, or RightScale. PaaS providers may offer the resources that IaaS provides, including storage, networking, servers or virtualization, as well as additional resources including e.g. the operating system, middleware, and runtime resources. Examples of PaaS include Windows Azure, Google App Engine, and Heroku. SaaS providers may offer the resources that PaaS provides, including storage, networking, servers, virtualization, operating system, middleware, and runtime resources, as well as additional resources including data and application resources. Examples of SaaS include Google Apps, Salesforce, or Office 365. Examples of SaaS may also include data storage providers, e.g. Dropbox, Microsoft SkyDrive, Google Drive, or Apple iCloud.

Clients 102 may access IaaS resources with different IaaS standards e.g. Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use http packages, standard Java APIs, JavaMail API, Java Data Objects (JDO), Java Persistence API (JPA), Python APIs, web integration APIs for different programming languages including e.g. Rack for Ruby, WSGI for Python, or PSGI for Perl, or other APIs that may be built on REST, HTTP, XML, or other protocols. Clients 102 may access SaaS resources through the use of web-based user interfaces, on web browsers including e.g. Google Chrome, Microsoft Internet Explorer, or Mozilla Firefox. Clients 102 also access SaaS resources through smartphone or tablet apps, including e.g. Salesforce Sales Cloud, or Google Drive app. Clients 102 may also access SaaS resources through the client operating system, including e.g. Windows file system for Dropbox.

Access to IaaS, PaaS, or SaaS resources may be authenticated by, e.g., security certificates, HTTPS, or API keys. Developers may use API keys with different encryption standards including, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may contain, without limitation, an operating system, and software. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and Tegra system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. An example of a multi-core processor is the AMD Phenom IIX2 or Intel Core i5 or Core i7.

Main memory unit 122 may be one or more memory chips capable of storing data and allowing any storage location to be directly accessed by the microprocessor 121. Main memory unit 122 may be volatile and faster than storage 128 memory. Main memory units may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices include keyboards, mice, trackpads, trackballs, touchpads, touch mice, multi-touch touchpads and touch mice, microphones, multi-array microphones, drawing tablets, cameras including e.g. CMOS sensors, accelerometers, infrared optical sensors, pressure sensors, magnetometer sensors, angular rate sensors, depth sensors, proximity sensors, ambient light sensors, gyroscopic sensors, or other sensors. Output devices include video displays, speakers, headphones, inkjet printers, laser printers, and 3D printers.

Some devices 130a-130n may combine multiple input or output devices, including e.g. Microsoft Kinect, Nintendo Wiimote, or Apple iPhone. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including e.g. Microsoft Kinect, Siri for iPhone by Apple, Google Now or Google Voice Search.

Additional devices 130a-130n have both input and output capabilities, including e.g. haptic feedback devices, touchscreen displays, or multi-touch displays. Touchscreen, multi-touch displays, touchpads, touch mice, or other touch sensing devices may use different technologies to sense touch, including e.g. capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including e.g. pinch, spread, rotate, scroll, or other gestures. Some touchscreen devices, including e.g. Microsoft PixelSense or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices e.g. a keyboard 126 and a pointing device 127, e.g., a mouse or optical pen. Furthermore, an I/O device may also provide storage and/or an installation medium 116 for the computing device 100. In still other embodiments, the computing device 100 may provide USB connections to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controllers 123. Display devices may include liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use e.g. stereoscopy, polarization filters, active shutters, or auto stereoscopy. Display devices 124a-124n may also be a head-mounted display (HMD). In some embodiments, display devices 124a-124n or the corresponding I/O controllers 123 may be controlled through or have hardware support for OpenGL or DirectX API or other graphics libraries.

In some embodiments, the I/O controller 123 may be a smart tv or a digital media receiver, that is connected to a display device 124a that is a television. Examples may include Boxee, a freeware home theater PC software developed by Apple TV by Apple; Boxee, Inc.; Google TV, an Android based platform by Google, among others. Some video game consoles, such as Playstation 3 or Xbox 360, may have many of the features of a smart tv. Some embodiments allow the user to connect to media streaming or purchasing services through the network 104. Some embodiments may allow the user to connect other computing devices 100 to stream media, either through wired connections, through a network 104 including e.g. a WiFi network. Examples include AirPlay mirroring for Apple devices or Nexus Q for Android version devices.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, e.g. computing devices 100a and 100b connected to the computing device 100, for example, via a network. These embodiments may include any type of software designed and constructed to use another computer's display device as a second display device 124a for the computing device 100. For example, in one embodiment, an Apple iPad may be connected to a computing device 100 and used as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128, e.g. one or more hard disk drives or redundant arrays of independent disks, for storing an operating system and other related software, and for storing application software programs. Examples of storage device 128 includes e.g. hard disk drive (HDD); optical drive including CD drive, DVD drive, or Blu Ray drive; solid-state drive (SSD); USB flash drive; or any other device suitable for storing data. Some storage device 128 may be non-volatile, mutable, ore read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including e.g. the Remote Disk for MacBook Air by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform, including e.g. Apple App Store for iOS, Google Play for Android OS, Chrome Webstore for Chrome OS, or Amazon Appstore for Android OS and Kindle Fire. An application distribution platform may install software for client devices 100 such as Google Android mobile devices such as Google Nexus smartphones or tablet devices; Apple iPhone or iPad devices; and Google Chromebooks, or on the Chrome web browser enabled devices, among other devices. An application distribution platform may include a repository of application, means of first and third party developers to submit applications, an application approval process, a means of purchasing a selected application by the user, user reviews and ratings of applications, popular applications, a database of purchased or installed applications by any users, among other features.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, ExpressCard network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1C and 1D typically operates under the control of operating systems, which control scheduling of tasks and access to system resources. The computing device 100 can be running any operating system e.g. any of the versions of the MICROSOFT WINDOWS operating systems, the different distributions of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, and WINDOWS 8 all of which are manufactured by Microsoft Corporation of Redmond, Wash.; MAC OS and iOS, manufactured by Apple Computer of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including e.g. the Chrome OS by Google, may be used on zero clients or thin clients, including e.g. Chromebooks.

The computer system 100 can be any workstation, telephone, desktop computer, laptop or notebook computer, netbooks, tablets, server, handheld computer, mobile telephone, smartphones or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsun GALAXY smartphones, e.g., operate under the control of Android operating system developed by Google, Inc. GALAXY smartphones can be controlled using the touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, or a NINTENDO WII device manufactured by Nintendo Co., Ltd., of Kyoto, Japan, an XBOX 360 device manufactured by the Microsoft Corporation of Redmond, Wash.

In some embodiments, the computing device 100 is a digital audio player e.g. the Apple IPOD, IPOD Touch, and IPOD NANO lines of devices, manufactured by Apple Computer of Cupertino, Calif. Some digital audio players may have other functionality, including e.g. a gaming system or any functionality made available by an application from a digital application distribution platform. For example, the IPOD Touch may access the Apple Appstore. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is a eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple Computer; a Samsung GALAXY family of smartphones manufactured by Samsung, Inc.; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

It should be understood that the systems described herein may provide multiple ones of any or each of those components and these components may be provided on either a standalone machine or, in some embodiments, on multiple machines in a distributed system. Any portions or components of the systems described herein may be implemented or deployed on a cloud 107, such as via software 108, platform 109 and infrastructure 110. The systems and methods described herein may be implemented as a method, apparatus or article of manufacture using programming and/or engineering techniques to produce software, firmware, hardware, or any combination thereof. In addition, the systems and methods described herein may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

### B. Emergency Call Handling System

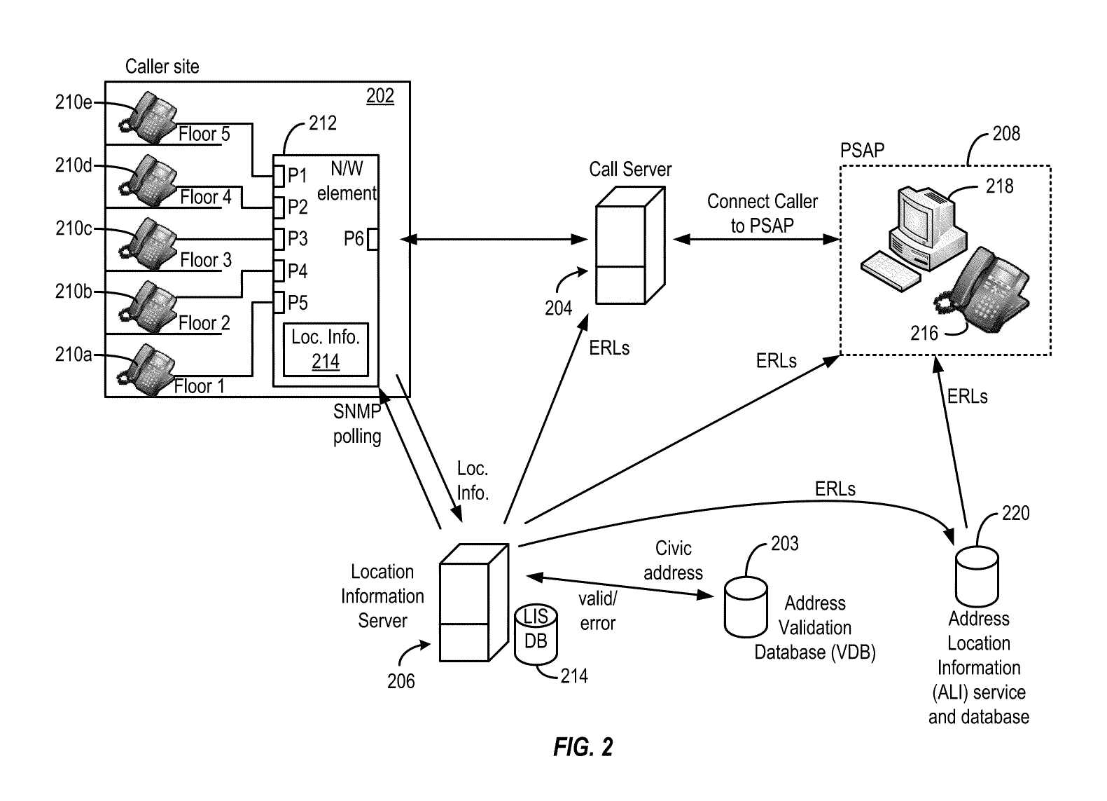

FIG. 2 shows an example system 200 for supporting voice over IP (VOIP) emergency calls. The system 200 includes a caller site 202, a call server 204, a location information server (LIS) 206, a public safety answering point (PSAP) 208, an address validation database 203 and address location information (ALI) service and database 220. The various entities shown in FIG. 2 can communicate with each other over one or more communications network, such as the networks 104 discussed above in relation to FIG. 1A. In some implementations, the networks 104 can include the Internet. A person skilled in the art will appreciate that the Internet can be established over multiple private and public network service providers. For example, the caller 201 may be connected to the Internet over a private communication network provided by the VOIP service provider. However, any network that can at least support VOIP emergency calls may be employed.

The caller site 202 can be, include or represent a building, a campus, or an establishment that includes one or more VOIP capable devices. For example, the caller site 202 can include five VOIP phones/terminals (“terminals”) 210a-210e. Each of the terminals 210a-210e can allow a user to make VOIP calls, including VOIP emergency calls such as E-911 and NG-911 calls. One or more of the terminals 210a-210e can include voice, video, and text capability. In some implementations, the terminals 210a-210e may include a telephony device or application. The terminals 210a-210e can be any type of device, such as any embodiments of client 102 (shown in FIG. 1A) designed and constructed to use or perform VOIP or otherwise to dial 911. The terminals 210a-210e can also include applications or programs that provide establishing an emergency call via modes other than dialing. For example, the terminals 210a-210e may include an application that accepts text, instant message, voice message, visual message, etc. from the caller and establishes an emergency call based on the content of the accepted messages.

In some implementations, the terminals 210a-210e can be situated at various locations within the caller site 202. For example, the terminal 201a may be placed on Floor 1, the terminal 201b is placed on floor 2, the terminal 210c is placed on floor 3, the terminal 210d is placed on floor 4, and the terminal 210e is placed on floor 5. The terminals 210a-210e can be situated within specific locations on their respective floors within the caller site 202. For example, the terminal 210a may be located in a specific room such as room number 101 on the floor 1 of the caller site 202. In some implementations, one or more of the terminals 210a-210e can be portable. The terminals 210a-210e can be moved from one location within the caller site 202 to another location within the caller site 202. For example, the terminal 210a may be moved from floor 1 to any of the other floors on the caller site 202. In another example, the terminal 210a may be moved between buildings of the caller site and/or between network elements of the caller site. The portability of the terminals 210a-210e can be facilitated by the presence of network termination points, connected to a switch, throughout the caller site 202. In some implementations, the portability can be facilitated by wireless local area network access points providing wireless access to the terminals 210a-210e.

As mentioned above, the terminals 210a-210e can be used by users to make emergency VOIP calls. In some implementations, the terminals 210a-210e can utilize the session initiation protocol (SIP) for making VOIP calls and for communicating with other entities of the system 200. In some other implementations, the terminal 201 may use other protocols such as H.323. Within the context of SIP used by the terminals 210a-210e to initiate, establish, and receive calls, each of the terminals 210a-210e can be capable of acting as a user agent. The user agent may provide or represent an endpoint of a connection and may be a logical entity that can act as both a client to send SIP requests and a server for responding to SIP requests. Additional information regarding the capabilities of a user agent can be found in the Internet Engineering Task Force (IETF) request for comments (RFC) 3261 (available on the IETF website), which is incorporated herein by reference in its entirety.

Each of the terminals 201a-210e can be communicably coupled to a network element 212. The network element 212 can include, but not limited to, Ethernet switches, network switches, access points, wireless local area network (WLAN) access points, wireless network access points, wireless network access switches, Fibre Channel switches, Asynchronous Transfer Mode (ATM) switches, etc. In some implementations, the network element 212 can be a multi-port network bridge that processes and forwards data at the data-link layer (i.e., layer 2) of the Open Systems Interconnection (OSI) model. In some other implementations, the network element 212 may be a router and can also route data at layer-3 and above. In yet other implementations, the network element 212 can also serve as a network gateway that connects a communication network of the call site 202 to the communication networks used by various other entities within the system 200.

The network element 212 can include several network interfaces for communicating with the terminals 210a-210e and with the network. For example, the network element 212 can include network interfaces P1, P2, P3, P4, P5, and P6. In some implementations, where the network element 212 is a WLAN access point, the network interfaces P1-P6 can include wireless communication channels (for example, a communication channel defined as per IEEE 802.11). In some implementations, where the network element 212 is a network switch (e.g., Ethernet switch), the network interfaces P1-P6 can include physical switch ports. While the system and methods herein may be generally described with respect to switch ports P1-P6, the systems and methods are also applicable to other network interfaces, such as wireless communication channels.

The network element 212 can also include a switching fabric such as, but not limited to, a crossbar switch, for switching data between the ports P1-P6. In some implementations, the ports P1-P5 can be connected to terminals 210a-210e, respectively, and the port P6 can be used by the network element to communicate with various entities within the system 202. The terminals 210a-210e can be connected to ports P1-P5 via their respective termination points. For example, each floor on the caller site 202, or each room in which the terminals 210a-210e can be placed, can include network connectors, such as RJ-45 connectors, to which the terminals 210a-210e can be connected. The network connecters, in turn, can be connected to the network ports, such as network ports P1-P5 via network cables, such as, but not limited to, twisted pair cables (e.g., category 5 cable), fiber optic cables, coaxial cables, etc. In some implementations, the network connectors may use wireless communications and protocols to connect to the network ports. For example, one or more of the network ports may support wireless communications.

In some implementations, the terminal points can include wireless devices, such as WLAN access points. In some such implementations, one or more of the terminals 210a-210e may include a wireless network interface to provide communication with the WLAN access point.

In some implementations, the network element 212 can store network interface location information 214 associated with each network interface. In some implementations, where the network interfaces are physical ports of a network switch, the network element 212 can store port location information 214 associated with each port P1-P5. Specifically, the network element 212 can store a list of port locations associated with the termination point for each port P1-P5. In some implementations, the locations associated with the terminal points can indicate the locations of WLAN access points. For example, as the termination point for port P1 is floor 1, the network element can store “floor 1” as the port location information associated with port P1. Similarly, the port location information associated with each of the ports P2-P5 can be floor2, floor 3, floor 4, and floor 5, respectively. In some implementations, the port location information can, in addition to the floor, include the room or location on the floor where the termination point is located. For example, the port location information associated with port P1 can include “room #1341” in addition to “floor 1”. Similar granularity can be added to the port location information associated with other ports. Additional information regarding port location information can be found in the Internet Engineering Task Force (IETF) request for comments (RFC) 3261 (available on the IETF website), which is incorporated herein by reference in its entirety.

In some implementations, where the network element 212 represents a wireless networking device, such as a WLAN access point, the P1-P6 can represent wireless network interfaces, and the location information 214 may store the location of the wireless network interfaces P1-P6 of the network element 212 as the stored port location information. In some implementations, location information of one or more wireless network interfaces associated with the network element 212 may include the location of the network element 212 within the caller site 202. For example, if the WLAN access point is located on “Floor 2” of the caller site 202, then the location information of one or more of the wireless interfaces P1-P6 can include the location “Floor 2” of the WLAN access point.

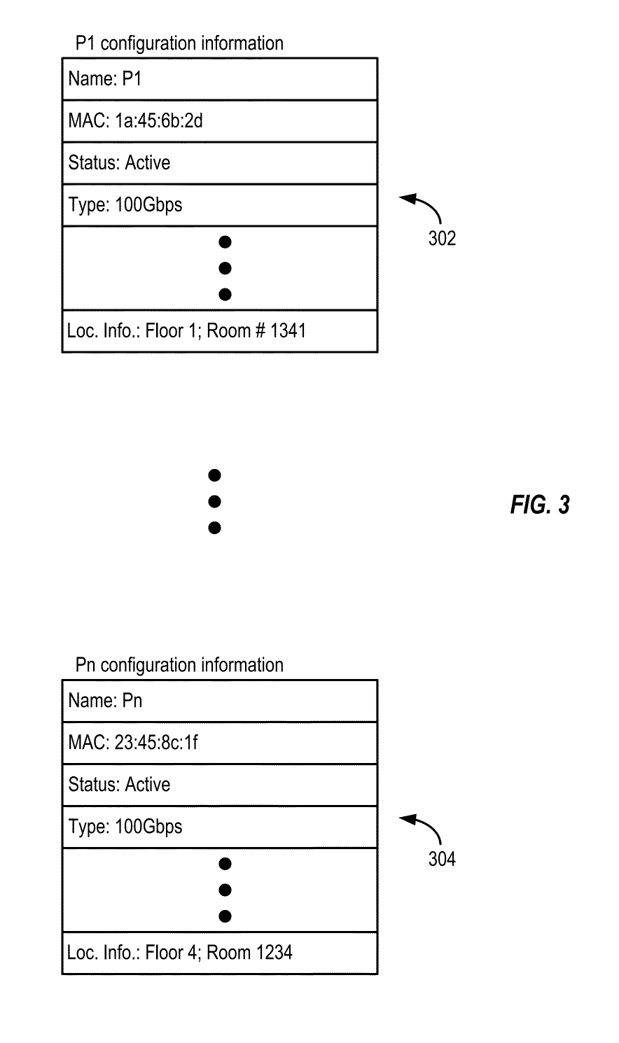

The network element 212 can store network interface location information associated with a network interface within network interface configuration information associated with that network interface. In some implementations, the network element 212 can store the port location information associated with a termination point of a port within the port configuration information associated with that port. FIG. 3 shows example port configuration information including port location information associated with a network element port. In particular, FIG. 3 shows port configuration information, 302 and 304, for ports P1 to Pn. The configuration information associated with each port can include fields such as, but not limited to, Name, MAC address, Status, Type, etc. In addition, the configuration information includes the port location information of the terminal point of the port. Example values associated with each field in the configuration information associated with ports P1 and Pn are shown in FIG. 3. In particular, the port location information associated with port P1 includes “Floor 1; Room #1341.” This port location information indicates that the terminal point associated with port P1 is located in Room #1341 on Floor 1 of the call site 202. Similarly, the port location information associated with port Pn includes “Floor 4; Room #1234.” This port location information indicates that the terminal point associated with the port Pn is located in Room #1234 on Floor 4 of the call site 202.

The network element 212 can include configuration information associated with ports P2-P6 where the configuration information associated with each port includes the port location information associated with that port. In some implementations, the configuration information can be stored in any type and form of database or storage of the network element. In some implementations, the configuration information and/or port location information can be stored in a management information base (MIB) database that is used for managing the network element 212. In some such implementations, the port location information can be stored in any one of the MIB objects defined by the MIB database.

In some implementations, an administrator may store the port location information within the configuration information associated with one or more ports. For example, the administrator may determine the location of the terminal point associated with the port. Further, the administrator may update any change in the port location information if re-cabling results in any port being associated with a network connector at a different location. In some other implementations, the administrator may automatically determine the port location information associated with a port with the aid of intelligent patch panels, cables, and network connectors. For example, a network connector, such as an RJ-45 jack, can be equipped with a device that stores the location of that network connector, and transmits the location information to a patch panel located at the network element. In some other implementations, the WLAN access point can store location information of the WLAN access point within the call site 202, and transmit the location information to the network element 212. A network management application can then access this information from the patch panel and update the configuration information associated with the ports to include the port's location information.

The network element 212 can also be configured to respond to requests received from various entities within the system 202 for the location information associated with the network element's ports. For example, the network element 212 can support management applications such as, but not limited to, simple network management protocol (SNMP). The network element 212 can be configured as an SNMP managed device, which can respond to SNMP commands received from an SNMP manager. In some implementations, the network element 212 may receive, from the SNMP manager located at the LIS 206, SNMP polling commands (such as SNMPGET command). The SNMP polling commands received from the LIS 206 can request for the configuration information (which includes port location information) associated with one or more ports of the network element 212. The network element 212 can respond with the configuration information, or more specifically the port location information, of one or more ports. In some implementations, as discussed further below, the LIS 206 can store the port location information as phone location information (LOC) associated with a particular terminal or VOIP phone connected to the one or more ports.

The network element 212 can be further configured to send notifications to the LIS 206 in the event that the network cabling connecting one or more ports changes. For example, if the terminal point of the port P1 is moved from floor 1 to floor 2, then the network element 212 can send a SNMPTRAP command to the LIS 206 notifying the LIS 206 of this change. In addition, the network element 212 can update the configuration information of the port to reflect the new port location information. For example, the network element 212 can update the port location information field of the configuration information of the port P1 from floor 1 to floor 2.

In some implementations, the network element 212 can also be configured to send a notification to the LIS 206 if the civic location of the network element 212 changes. For example, if the network element 212 is moved from one building to another at the caller site 202, the network element 212 can automatically send a message to the LIS 206 notifying the LIS 206 of the change in the network element's 212 location. The message can, for example, be an SNMPTRAP message sent by the network element 212 to an SNMP manager located at the LIS 206.

Although at times generally described as using SNMP command and messages, the systems and methods described herein may be use any type and form of protocols and communication scheme for communications, such as to send queries and receive notifications as described herein.

Referring again to FIG. 2, the system 200 also includes the LIS 206. The LIS 206 serves as a server for and repository of location information of terminals 210a-210e. The LIS can store location information in an LIS database 216, which is communicably coupled to or part of the LIS 206. The LIS 206 can provide one or more entities within the system 200 location information regarding the terminals 210a-210e. For example, the call server 204, upon receiving an emergency call made by one of the terminals 210a-210e, can request the LIS 206 for the location information of the terminal making the emergency call. The LIS 206, in response to the request, can return the location information of the requested terminal to the call proxy server 204. The location information can include the civic address of the caller site 202 in addition to the floor/room number of the terminal Based on the location information received from the LIS 206, the call proxy server 204 can route the emergency call to the appropriate PSAP and include the location information in the message sent to the PSAP 208. The PSAP 208 can, in turn, communicate the location information to emergency responders. In some implementations, the LIS 206 can be configured to send for storage location information of terminals 210a-210e to the ALI service and database, which in turn, can provide the location information to other entities within the system 200.

In some implementations, the LIS 206 can provide the location information to various entities within the system 200 in the form of an extensible markup language (XML) document such as a presence information data/document format location object (PIDF-LO), or in the form of a location key (LK). The PIDF-LO can include the location information of a terminal within the XML document, while the LK includes an address of the LIS 206 from where the location information of the terminal can be obtained. Typically, a terminal includes the PIDF-LO within an emergency call initiation message sent to the call server 204. In instances where the terminal is incapable of including the PIDF-LO, or where it may be preferred or desired that the LIS 206 store the location information on behalf of the terminal, the terminal 201 can instead include the LK within the emergency call initiation message, which LK can be used by the call server 204 to access location information of the terminal from the LIS 206.

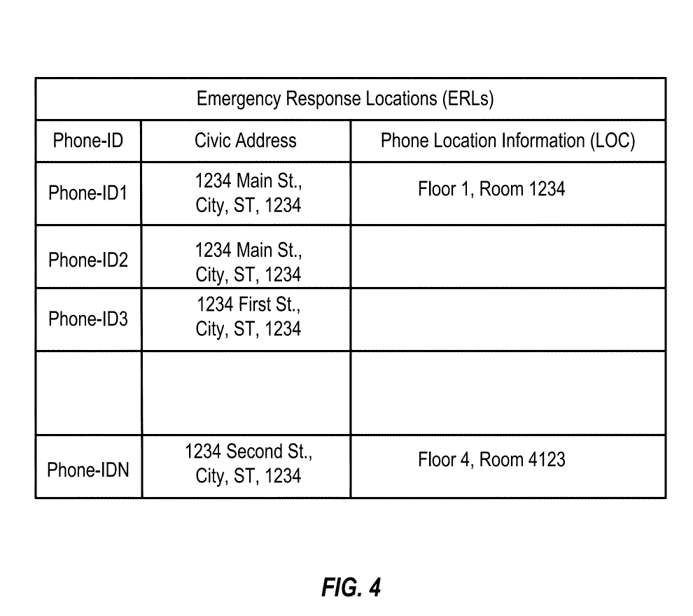

In some implementations, the LIS 206 can store location information associated with the terminals 210a-210e in the form of emergency response locations (ERLs). For example, FIG. 4 shows a list of ERLs associated with a corresponding list of phone-IDs. In some implementations, the ERL can include two portions: a civic address and phone location information (LOC). In some implementations, the ERL can include other information in addition to the civic address and LOC. Generally, the ERL can indicate a location to which emergency responders can be dispatched. To this end, ERL provides location information that is specific enough to provide a reasonable opportunity for the emergency response team to quickly locate the phone, and hence the caller, making the emergency call. The civic address can indicate the street address of the caller site where the phone is located. In addition, the LOC can include additional information such as floor number, room number, etc. within the caller site at the civic location. For example, the civic address for the phone identified by Phone-ID1 is “1234 Main St., City, ST, 12345.” Assuming that the Phone-ID1 corresponds to the terminal 210a shown in FIG. 2, the civic address can refer to the civic address of the caller site 202. Further, the LOC: “Floor 1, room 1234” can indicate that the terminal 210a is located on floor 1 and room 1234 of the caller site 202. Similar ERLs (i.e., civic address and LOC) corresponding to other phone-IDs can be stored by the LIS 206. In some implementations, the LIS 206 can store the ERLs associated with various phone-IDs in the LIS database (LIS-DB) 214 (shown in FIG. 2).

In some implementations, the LIS 206 can store partial ERLs associated with one or more phone-IDs without the LOC. For example, as shown in FIG. 4, the LIS 206 ERLs associated with the phone-ID2 and the phone-ID3 only include the civic address, and do not include the LOC. The LIS 206 may store only the validated civic address of the caller site 202, and separately (and, in some instances, dynamically in response to an ERL request) obtain the LOC associated with a phone at the caller site 202 when required. In some implementations, the LIS 206 can obtain the LOC periodically over a certain duration (e.g., daily). By obtaining the LOC information dynamically or periodically, the LIS 206 can alleviate the risk associated with the location of the caller changing after the LOC information has been stored in the ERL. Thus, in instances where the complete ERL (civic address and the LOC information) is stored in the LIS-DB 214, if the location of the caller were to change after the ERL is stored, the outdated LOC information would be sent to the PSAP 208 by the LIS 206. This may result in the emergency responders being directed to a location where the emergency caller is no longer present. The network element 212 updates the LOC information associated with a terminal each time the terminal is moved to a different location. By storing only the civic address associated with the network element 212, and dynamically obtaining the LOC information of the emergency caller from the network element 212, the LIS 206 can provide the PSAP the most up-to-date ERL associated with the emergency caller.

The LIS 206 can also communicate with an address validation database or service (VDB) 203 for validating civic addresses. The VDB 203 can include information that describes current and valid civic addresses within a specific geographical area. The current and valid civic address can be defined by a master street address guide (MSAG), which can be maintained by emergency network service provider. In some implementations, the VDB 203 can be configured to receive a validation request from the LIS 206 containing a civic address, and to determine if the received civic address is valid. The VDB 203 can respond with a message indicating that the civic address is valid or can respond with an error message upon determining that the civic address is invalid. In some implementations, the VDB 203 can be distributed across multiple databases, for example, with different VDBs serving different regional areas. In some implementations, the LIS 206 can be configured to store the civic address within an ERL associated with a Phone-ID only after the civic address has been verified by the VDB 203. In some implementations, the LIS 206 can be configured to periodically re-verify the civic address stored within the ERLs of one or more Phone-IDs. In some other implementations, the LIS 206 can be configured to verify the civic address of a network element 212 upon receiving a message (such as SNMPTRAP) from the network element 212 indicating that the network element 212 has been relocated.

As mentioned above, the LIS 206 can be configured to perform SNMP polling to obtain the information on terminals 210a-210e connected to the network element 212 and to obtain location information of the ports of the network element 212 at the caller site 202. In some implementations, the LIS 206 can be configured to include an SNMP manager that can send SNMP commands, such as SNMPGET to obtain MAC information (such as MAC addresses) associated with the terminals 210a-210e connected to the network element 212 and port configuration MIB objects associated with one or more ports of the network element 212.

As discussed above in relation to FIG. 3, the network element 212 can store the location information associated with a port within the port configuration of that port. The LIS 206 can send SNMP commands to request the values of the port configuration MIB for one or more ports of the network element 212. The information received from the network element 212 can include the port location information for the one or more ports in addition to other port configuration information such as MAC address, port status, etc. For example, referring to FIG. 3, the LIS 206 can receive the port configuration information associated with the port P1. The port configuration information associated with the port P1 can include “Floor 1; Room #1341,” which indicates the location of the termination point associated with the port P1. The LIS 206 can similarly obtain the port configuration information, and thus the embedded port location information, associated with other ports P2-P5 of the network element 212.

The LIS 206 can also send management commands (e.g., SNMP commands) to obtain the identities of the terminals connected to the ports of the network element 212. For example, the LIS 206 can send SNMP commands to obtain the MAC and/or IP addresses of each of the terminals 210a-210e connected to the ports P1-P5, respectively, of the network element 212.

The LIS 206 can combine the location information of the ports of the network element 212 with the identities of the terminals connected to the ports of the network element 212 to determine the LOC for the terminals 210a-210e. For example, the LIS 206 can determine that the LOC for the terminal 210a is “Floor 1, Room #1341,” by determining that the terminal 210a is connected to the port P1, and by determining that the port location information stored in the port configuration information for port P1 is “Floor 1, Room #1341.” In a similar manner, the LIS 206 can determine the LOC for other terminals 210b-210e.

It should be noted that in determining the LOC for one or more terminals connected to the network element 212, the LIS 206 may not refer to or store a network map for the call site 202. Certain methods for determining LOC rely on storing a network map for a call site, where the network map includes manually updated data indicating the location of each port within the call site. For example, the network map for the call site 202 could include the port location information for each of the ports of the network element 212. Polling can be performed to first determine the port to which the terminal is connected, and then the network map can be used to obtain the port location information of that port. However, maintaining a network map at the LIS 206 can be cumbersome and challenging as the network map needs to be manually updated. Thus, if the network map stored at the LIS 206 were old, the LIS 206 may potentially determine an old and incorrect address for a terminal. Further, incorrect terminal location may be communicated to the emergency responders if a change in the terminal location has not been reflected in the network map before the terminal initiates an emergency call.

Storing the port location information within the configuration information of each port (as shown in FIGS. 3 and 4) alleviates the need to maintain or use a network map at the LIS 206. Instead of maintaining a network map at the LIS 206, network administrators at the call site 202 can update any changes in the port location information by making corresponding changes within the port configuration, and allow the LIS 206 obtain the updated data as part of the polling process performed by the LIS 206. The network administrators at the call site 202 need not bear the burden to update each and every LIS 206 with the new port location information.

In some implementations, the LIS 206 can be configured to perform SNMP polling at regular intervals (e.g., predetermined amount of time in seconds, minutes, hours or days) to determine the LOC associated with one or more terminals. In some other implementations, the LIS 206 may be configured to perform SNMP polling also upon receiving a notification from the network element 212 that one or more terminals have been moved (e.g., upon receiving an SNMPTRAP command).

Referring again to FIG. 2, the system 200 further includes a call server 204. The call server 204 can perform several functions such as serving as a call proxy for one or more terminals at the call site 202, a call routing server for routing the calls made by the terminals to an appropriate PSAP based on the LOC of the terminal, etc. In some implementations, where the terminals 210a-210e employ the SIP protocol for making VOIP calls, the call server 204 can be a SIP call server. In some implementations, the call server 204 can be configured to function as a proxy server for the one or more terminals 210a-210e. In its role as a proxy server, the call server 204 can act as an intermediary between the terminals 210a-210e and another call server. In some implementations, the call server 204 can obtain location information (e.g., ERL) associated with the terminals 210a-210e from the LIS 206 on behalf of the terminals 210a-210e, and include the location information downstream to another call server that can connect the terminals 210a-210e to the appropriate PSAP.

To the extent that the call server 204 complies with the national emergency number association's (NENA) i2 and i3 specifications, the call server 204 can, for example, provide or assume the role of a call server or an emergency call routing function (ECRF) that is responsible of routing incoming emergency calls to a PSAP appropriate to the caller's location. The NENA i2 and i3 specifications are detailed in: “NENA Interim VoIP Architecture for Enhanced 9-1-1 Services (i2) NENA 08-001, Issue 1 Dec. 6, 2005” and “NENA Detailed Functional and Interface Standards for the NENA i3 Solution NENA 08-003 v1, Jun. 14, 2011,” both of which are incorporated herein by reference in their entirety.

The system 200 further includes an ALI service and database 220 for storing ERLs associated with terminals 210a-210e. In some implementations, the ALI service and database 220 can receive completed ERLs associated with one or more terminals 210a-210e from the LIS 206 to be stored in the ALI database 220. The ALI service and database 220 can store the ERLs and provide the stored ERLs to one or more entities (such as the PSAP 208) within the system 200.

The PSAP 208 is the public safety answering point responsible for answering or that answers emergency calls made by the caller at any one of the terminals 210a-210e. Once the SIP server 204 connects a terminal 210a-210e to the PSAP 203, media streams (e.g., audio streams, video streams, and text) can be exchanged between the terminal and the PSAP 203. The PSAP 203 may include a terminal 216 and a computing device 218. The terminal 216 can be a VOIP enabled phone for reproducing received audio streams and generating audio streams to be sent to the terminals 210a-210e. The computing device 218 can reproduce video streams and text received from the caller at the terminals 210a-210e and can also display the location of the caller on a map. The computing device 214 can also be used by the emergency personnel to enter additional data and information received while communicating with the caller during the emergency call. The additional data and information can be transmitted to emergency service responders such as the police, the fire department, emergency medical technicians, and paramedics.

### C. Example Operations of the LIS

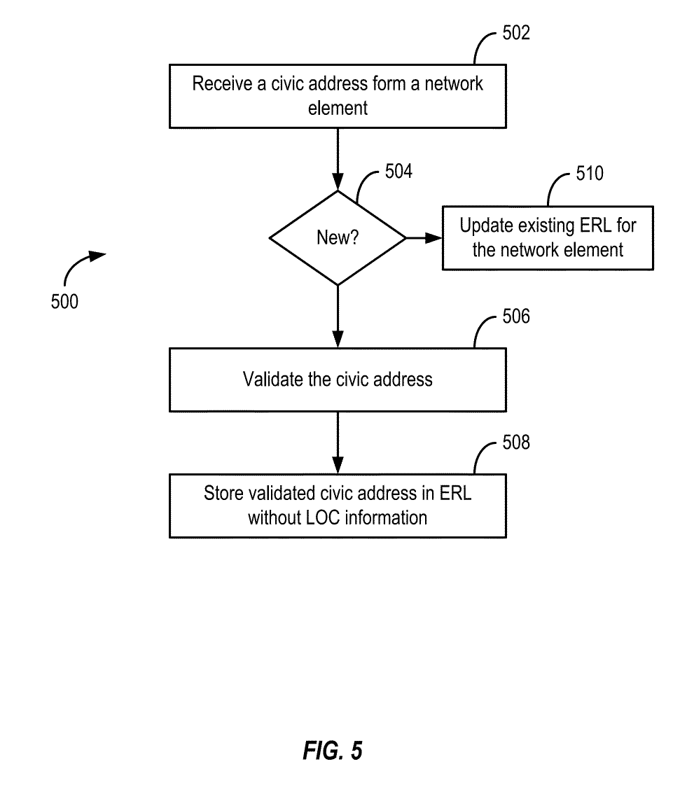

The discussion now turns to the operations of the LIS 206 related to the location information associated with the terminals 210a-210e. FIG. 5 shows an example flow diagram of a process 500 for processing, at a location information server (such as the LIS 206 shown in FIG. 2), emergency response locations (ERLs) associated with terminals at a call site. In some implementations, the process 500 can be executed by the LIS 206 when a new network element is added to the network or when the network element is moved to a new civic location. In particular, the process 500 includes receiving a civic address from a network element (step 502); determining whether the civic address is new (step 504); if the civic address is new, validating the received civic address (step 506); and storing the validated civic address in the ERL without terminal location information (LOC) (step 508); and if the civic address is not new, updating existing ERLs for the network element (510).

In further details, the LIS receives a civic address from a network element (step 502). In some implementations, the LIS may receive a civic address from a new network element added to the network at a call site. In some other implementations, the LIS may receive a civic address from a network element that has been moved to a different location. For example, referring to FIG. 2, the LIS 206 may receive the civic address from the network element 212 when the network element 212 is first added to the network at the call site 202. The LIS 206 may also receive the civic address if the network element 212 is moved from one location within the call site to another location within the call site 202 or to a different call site altogether.

The process 500 further includes determining whether the civic address is new (step 504). The LIS 206, upon receiving the civic address of the network element 212, compares the received civic address with civic address previously validated and stored in the LIS DB 214. For example, the LIS 206 may compare the received civic address with the civic addresses stored in the ERLs in the LIS DB 214 (as shown in FIG. 3). If the received civic address is not found in the LIS DB 214, the LIS 206 may determine or conclude that received civic address is new.

The process 500 also includes validating the received civic address (step 506). If the received civic address is new, the LIS 206 can validate the civic address by sending the new civic address to the address validation database 203. As discussed above, the address validation database or service 203 can include a MSAG that maintains a database of all valid civic addresses for a particular service area. If the civic address is valid, the LIS 206 can receive a message indicating that the civic address is valid from the address validation database 203.

The process 500 further includes storing the civic address in ERLs without LOC information (step 508). If the LIS 206 receives validation from the address validation database 203 for the received civic address, the LIS 206 can save the civic address in the LIS DB 214 and associate the stored civic address with the network element 212. In some implementations, the LIS 206 can store the civic address in the LIS DB 214 without storing any LOC of the terminals connected to the network element 212. As will be discussed further below, in some implementations, the LIS 206 can obtain the LOC of one or more terminals connected to the network element 212 separately from obtaining the civic address of the network element 212 and combine the stored civic address with the obtained LOC to generate an ERL for that terminal. In some implementations, the LIS 206 can obtain the LOC of one or more terminals after obtaining the civic address of the network element 212 if the network element 212 is determined to be a new network element. In some implementations, the LIS 206 can obtain the LOC of one or more terminals, after obtaining the civic address of the network element 212, periodically over some duration. For example, the LOC can be obtained once every day.

In some implementations, the LIS 206 can obtain the LOC of one or more terminals connected to the network element 212 dynamically, and combine the stored civic address with the obtained LOC information to generate an ERL for that terminal By obtaining the LOC information dynamically, the LIS 206 can alleviate the risk associated with the location of the caller changing after the LOC information has been stored in the ERL. Specifically, by storing only the civic address associated with the network element 212, and dynamically obtaining the LOC information of the emergency caller from the network element 212, the LIS 206 can provide the PSAP the most up-to-date ERL associated with the emergency caller.

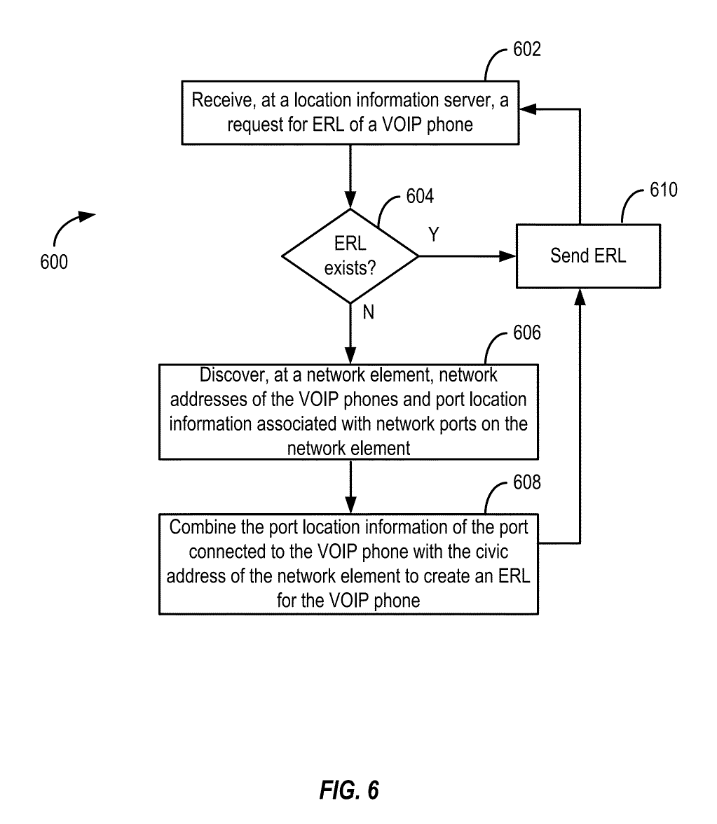

FIG. 6 shows an example flow diagram of another process 600 for processing, at a location information server (such as the LIS 206 shown in FIG. 2), emergency response locations (ERLs) associated with terminals at a call site. In particular, the process 600 includes steps performed by the LIS in response to receiving a request for an ERL of a VOIP phone. The process 600 includes receiving, at a location information server, a request for an ERL of a VOIP phone (step 602), determining whether the ERL of the requested VOIP phone is stored in the database (step 604), upon determining that the requested ERL is not stored in the database, discovering, at a network element, network addresses of the VOIP phones and port location information associated with network ports on the network element (step 606), combining the port location information of the port connected to the VOIP phone with the civic address of the network element to create an ERL for the VOIP phone (step 608), and sending the ERL to the requester (step 610).

The process includes receiving, at a location information server, a request for an ERL of a VOIP phone (step 602). As discussed above in relation to FIG. 2, the LIS 206 may receive a request for an ERL of a VOIP phone form several entities within the system 200. For example, the LIS 206 may receive a request for the ERL of a VOIP phone (such as any one of the terminals 210a-210e) from the call server 204, from the PSAP 208, or form the VOIP phone itself. In some implementations, the request may be received from the call server 204 or the PSAP 208 in response to an emergency call initiated by the VOIP phone. In some implementations, the request may be received from the VOIP phone so that the VOIP phone may include the ERL (or a key to the ERL) within an emergency call message. In some implementations, the request may include an identifier for the requested VOIP phone. In some such implementations, the identifier can be, but not limited to, a MAC address, an IP address, or any identifier that uniquely identifies the VOIP phone.

The process 600 further includes determining whether the ERL of the requested VOIP phone is stored in the database (step 604). As discussed above in relation to FIG. 4, the LIS 206 can store ERLs of several VOIP phones in the LIS DB 214. In some instances, the ERL associated with a VOIP phone may not be complete in the LIS DB 214. For example, as shown in FIG. 4, the ERL associated with Phone-ID2, while including the civic address, does not include the LOC.

The process 600 also includes, upon determining that the requested ERL is not stored in the database, discovering, at a network element, network addresses of the VOIP phones and port location information associated with network ports on the network element (step 606). As discussed above in relation to FIG. 2, the LIS 206 can send network management commands (such as SNMP commands) to the network element 212 to discover the MAC addresses of the VOIP phones connected to the network element, and to receive the port location information associated with the ports of the network element 212. With the received information from the network element 212, the LIS 206 can identify the port to which the requested VOIP phone is connected, and determine the LOC information for the VOIP phone to be the port location information associated with the port. In some implementations, the LIS 206 can obtain the LOC of the VOIP phone connected to the network element 212 separately from obtaining the civic address of the network element 212 and prior to receiving the request for the ERL for the VOIP phone. In some implementations, the LIS 206 can obtain the LOC of one or more terminals, after obtaining the civic address of the network element 212, periodically over some duration. For example, the LOC can be obtained once every day.

The process 600 also includes combining the port location information of the port connected to the VOIP phone with the civic address of the network element to create an ERL for the VOIP phone (step 608). Once the LIS 206 determines the LOC of the VOIP phone, the LIS 206 can update the ERL of the VOIP phone stored in the LIS DB 214. For example, referring to FIG. 4, the LIS 206 can combine store the port location information of the port to which the VOIP phone is connected in the LOC field of the Phone-ID associated with the VOIP phone. It should be noted that, in some implementations, the LIS 206, unlike some other techniques for determining the ERL of a VOIP phone, does not refer to a locally stored network map to determine port location information of the port to which the VOIP phone is connected. Instead, the LIS 206 receives the port location information from the network element 212 as part of the response to the management network query sent by the LIS 206. As the port location information is received from the network element, the overhead for creating and maintaining up-to-date network maps of various network elements at the LIS 206 is alleviated. Furthermore, by storing only the civic address associated with the network element 212, and separately (and, in some instances, dynamically) obtaining the LOC information of the emergency caller from the network element 212, the LIS 206 can provide the PSAP 208 (or any other requester) the most up-to-date ERL associated with the emergency caller.

The process 600 further includes sending the ERL to the requester (step 610). Once the ERL of the VOIP phone is complete, the LIS 206 can send the complete ERL to the requesting entity. In some implementations, the requesting entity can be the PSAP 208. In some implementations, the LIS 206 may send the complete ERL as a text string to the requester. In some other implementations, the LIS 206 may encode the complete ERL and send the encoded complete ERL to the requester. In some other implementations, the LIS 206 may send the complete ERL to the requester in the form of a PIDF-LO. In some implementations, the LIS 206 may send the complete ERL to an address location information (ALI) service 220 for storing in an ALI database. As discussed above, the ALI database may be accessed by the PSAP 208.

In some implementations if the LIS 206 determines that the civic address within an ERL is incomplete, the LIS 206 can perform the process 500 discussed above in relation to FIG. 5 in conjunction with the process 600 to determine the complete ERL of the VOIP phone.

Although the above system and methods may be generally described with respect to a port of a network element, the system and methods are applicable to any network interface of a network element. For example, the network interfaces can include physical as well as wireless network interfaces.

While various embodiments of the methods and systems have been described, these embodiments are exemplary and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the exemplary embodiments and should be defined in accordance with the accompanying claims and their equivalents.

1. A method for determining a location of a phone of a network device by a location information server for an emergency response location, the method comprising:
(a) storing, by a location information server (LIS), in a database a civic address assigned to a network device, intermediary to a plurality of phones and a call server, for an emergency response location (ERL), location information of the phone connected to the network device at the civic address to be included with the civic address for the ERL record for the phone and to be obtained from the network device;
(b) sending, by the LIS, a query to the network device to obtain information on a port from the plurality of ports of the network device connected to the phone;
(c) receiving, by the LIS from the network device in response to the query, location information for the port configured on the network device; and
(d) creating, by the LIS, the ERL record for the phone to include the location information of the port of the phone received by the network device with the civic address stored by the LIS.

2. The method of claim 1, wherein (a) further comprises validating, by the LIS, via an address validation service the civic address assigned to the network device.

3. The method of claim 2, wherein the address validation service includes a master street address guide (MSAG).

4. The method of claim 1, wherein (a) further comprises storing, by the LIS, a partial ERL record in the database comprising the civic address.

5. The method of claim 1, wherein (b) comprises sending, by the LIS, a message to the network device querying a value of a predetermined configuration element storing the location information for the port.

6. The method of claim 5, wherein the message includes a simple network management protocol (SNMP) message and wherein the configuration element includes a management information base (MIB) entry.

7. The method of claim 1, wherein (b) comprises sending the query to the network device periodically over certain duration.

8. The method of claim 1, wherein (b) comprises receiving, by the LIS, a request for the ERL of a phone of an emergency caller connected to the network device at the civic address and, responsive to the request, sending the query.

9. The method of claim 8, further comprising determining a location of the phone of the emergency caller from the location information received from the network device, the location provided to a public safety answering point (PSAP) to respond to the emergency call.

10. The method of claim 1, wherein location information for the port includes at least one of building, floor or room information of the phone and stored on the network device.

11. The method of claim 1, wherein (d) further comprises creating a complete ERL record by combining the location information obtained from the network device with the civic address stored by the LIS.

12. The method of claim 11, further comprising sending, by the LIS, the complete ERL record to an address location information (ALI) service to store in an ALI database.

13. A system for determining a location of a phone of a network device by a location information server for an emergency response location, the system comprising:
a location information server (LIS) configured to store in a database a civic address assigned to a network device, intermediary to a plurality of phones and a call server, for an emergency response location (ERL), location information of the phone connected to the network device at the civic address to be included with the civic address for the ERL record for the phone and to be obtained from the network device; and
wherein the LIS is configured to send a query to the network device to obtain information on a port from the plurality of ports of the network device connected to the phone, and in response to the query, receive from the network device location information for the port configured on the network device; and create the ERL record for the phone to include the location information of the port with the civic address.

14. The system of claim 13, wherein the LIS is further configured to validate via an address validation service the civic address assigned to the network device.

15. The system of claim 13, wherein the LIS is further configured to store a partial ERL record in the database with the civic address only, but without the location information.

16. The system of claim 13, wherein the LIS is further configured to send a message to the network device querying a value of a predetermined configuration element storing the location information for the port.

17. The system of claim 16, wherein the message includes a simple network management protocol (SNMP) message and wherein the configuration element includes a management information base (MIB) entry.

18. The system of claim 13, wherein the LIS is further configured to send the query to the network device responsive to receiving a request for the ERL of a phone of an emergency caller connected to the port of the network device at the civic address.

19. The system of claim 13, wherein the LIS is further configured to send the query to the network device periodically over certain duration.

20. The system of claim 13, wherein location information for the port includes at least one of building, floor or room information of the phone and stored on the network device.

21. The system of claim 13, wherein the LIS is further configured to create a complete ERL record for the phone by combining the location information obtained from the network device with the civic address stored by the LIS.

22. The system of claim 21, wherein the LIS is further configured to send the complete ERL record of the phone to an address location information (ALI) service to store in an ALI database.

23. The system of claim 21, wherein the LIS if further configured to send the complete ERL record of the phone in the form of a presence information data/document format location object (PIDF-LO).

24. A method for determining a location of a phone of a network device by a location information server for an emergency response location, the method comprising:
(a) storing, by a location information server (LIS), in a database a partial emergency response location (ERL) record comprising a civic address assigned to a network device, intermediary to a plurality of phones and a call server, the partial ERL record to be completed with at least a location information of a phone at the civic address stored on the network device;
(b) sending, by the LIS, a query to the network device to obtain location information on a port from the plurality of ports of the network device connected to the phone;
(c) receiving, by the LIS from the network device in response to the query, the location information for the port configured on the network device;
(d) completing, by the LIS, the ERL record for the phone by storing the location information of the port received from the network device with the civic address stored by the LIS;
(e) receiving, by the LIS, a request for the ERL of the phone of an emergency caller at the civic address, the phone connected to one of a plurality of ports of the network device; and
(f) providing, by the LIS, in response to the request for the ERL, the complete ERL record for handling an emergency call of the emergency caller from the phone by a public safety answering point.

25. The method of claim 24, wherein (a) further comprises validating, by the LIS, via an address validation service the civic address assigned to the network device.

26. The method of claim 24, wherein (b) comprises sending, by the LIS, a message to the network device querying a value of a predetermined configuration element storing the location information for the port.

27. The method of claim 24, wherein location information for the port includes at least one of building, floor or room information of the phone and stored on the network device.

28. The method of claim 24, wherein (b) further comprises sending the query to the network device periodically over certain duration.

29. The method of claim 24, wherein (b) further comprises sending the query to the network device in response to (e).
